(19) United States
(12) Patent Application Publication
(10) Pub. No.: US 2005/0144089 A1
(43) Pub. Date: Jun. 30, 2005

(54) Shipment and delivery management system

(75) Inventor: Fumitaka Kamiyama, Kashiwa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HITACHI, LTD., Tokyo (JP)

(21) Appl. No.: 10/993,714

(22) Filed: Nov. 19, 2004

(30) Foreign Application Priority Data
Dec. 25, 2003 (JP) 2003-428620

(51) Int. Cl. G06F 17/60

(52) U.S. Cl. 705/26

(57) ABSTRACT

A dealer server for managing product transaction information involving a purchaser, dealer, and supplier includes a communication interface to couple the dealer server to a purchaser computer and a supplier computer; a processor to process information; and a storage device to store the product transaction information involving the purchaser, dealer, and supplier. The dealer sever is configured to store a shipment management table on a on storage device of a dealer server, the shipment management table including purchaser transaction reference information, dealer transaction reference information, supplier transaction reference information, product delivery date requested by the purchaser, the scheduled shipping date of the product by the supplier, the requested product delivery date being generated by purchase order information received from the purchaser and the anticipated shipping date being generated by information provided by the supplier. The dealer server compares the requested product delivery date and the anticipated shipping by accessing the shipment management table stored in the storage device, and determines whether or not the anticipated shipping date satisfies the requested delivery date requested by the purchaser, and transmits a message notifying at least to one of the purchaser and supplier of a delivery problem if the anticipated shipping date is determined to be unsatisfactory with respect to the requested delivery date, the message being transmitted to a network coupled to the dealer server.

### CROSS-REFERENCES TO RELATED APPLICATIONS

This application claims priority to Japanese Patent Application No. 2003-428620, filed on Dec. 25, 2003.

### BACKGROUND OF THE INVENTION

The present invention relates to a shipment and delivery management system that manages the shipment and delivery of articles of trade using computers.

A dealer purchases an article of trade (or a product) from a supplier and sells to a purchaser, and the shipment and delivery of the article are managed by the dealer. To manage such shipment and delivery information, the dealer generally uses the following to identify a relevant article of trade. In a transaction between the dealer and purchaser, the dealer uses a purchase order number used by the purchaser. A dealer may also use order item numbers provided on the purchaser's order form. An order item number is assigned to each type of products ordered. Accordingly, a single order form may have a plurality of order item numbers associated with it if a plurality of product types are ordered. The product name is also used by the dealer to management the transaction with the purchaser.

To management transaction between the dealer and the supplier, the dealer uses the dealer's purchase order number, dealer's order item number, and the product name.

The supplier generates invoices to manage the transaction with the dealer. The invoice has an invoice number and one or more invoice item numbers, and indicates the dealer's purchase order number and order item numbers for reference. Various delivery management systems have been proposed. One example is such that a plurality of inquiries about the delivery date are made to a supplier by an ordering management center. The ordering management center or a user thereof is notified of the returned dates of delivery. (Japanese Unexamined Patent Publication No. 2002-297972.

### BRIEF SUMMARY OF THE INVENTION

The above-mentioned prior art has a problem. As mentioned above, a dealer purchases an article of trade from a supplier, and sells it to a purchaser. The dealer performs the shipment and delivery management on the article of trade. In each step of shipment forecast notification, shipment result notification, and delivery notification, problems can occur. Such problems include discrepancy the number of products (or articles of trade) ordered and the actual number of products that are delivered and discrepancy in requested delivery date requested and the actual date of delivery. If such a situation occurs, the dealer needs to quickly resolve the problem between the purchaser and the supplier.

This is not easy to do under the conventional transaction management system. As mentioned above, the purchase order numbers and the order item numbers used in ordering and delivery management between the purchaser and the dealer are different from those used in ordering and delivery management between the dealer and the supplier. The transaction between the purchaser and dealer is referred to as a first transaction, the transaction between the dealer and supplier is referred to as a second transaction.

The purchase order numbers, order item numbers, and any other reference numbers used to identify the transaction between the purchaser and dealer are referred to as “first transaction reference numbers” or “first transaction numbers.” Accordingly, the first transaction reference numbers include the purchaser's reference and the dealer's reference numbers, as long as these reference numbers relate to the transaction between the purchase and the dealer. The reference numbers relating to the transaction between the dealer and supplier are referred to as “second transaction reference numbers” or “second transaction numbers.”

When the dealer attempts to resolve a problem between the purchaser and supplier, the dealer needs the purchase order numbers for both the first and second transactions to cross reference them, which can be time consuming.

For example, the dealer manages shipment based on order numbers in received order information created based on the purchaser's ordering information. The supplier establishes invoice numbers and invoice item numbers based on order information created based on the dealer's ordering information. If any problem occurs, the dealer needs, therefore, both types of transaction reference numbers to correctly identify the products in question. This is done generally by relating one by one all the first transaction numbers to the second transaction numbers.

Japanese Unexamined Patent Publication No. 2002-297972 discloses a method for managing only the delivery date of products. It does not harmonize transaction data used by the purchaser, dealer, and supplier, such as ordering data, received order data, shipment forecast data, shipment result data, and invoice data. Therefore, it is still difficult to identify the problematic articles of trade.

The shipment and delivery management system (or product transaction management system) according to embodiments of the present invention is obtained by providing the following means to a shipment and delivery system for managing the shipment and delivery of articles of trade among purchaser, dealer, and supplier: a standard table generating means which generates a standard management table containing information relating to articles of trade of the purchaser, dealer, and supplier, and the shipment and delivery lead times and shipment forecast notification lead times for articles of trade; a generating means which generates a shipment management table, containing management numbers for articles of trade used by the purchaser, dealer, and supplier, based on the dealer's received order data created based on article of trade ordering data from the purchaser, ordering data for the supplier created based on the dealer's received order data, and shipment and delivery data from the supplier; and a control means which manages the shipment and delivery of articles of trade based on the information contained in the shipment management table.

According to one embodiment, the dealer creates shipment management table data. This is done by adding the following data to standard management table data containing items required for shipment and delivery management: some items of purchaser ordering data, dealer received order data, and dealer ordering data, and the supplier's invoice number and invoice item number. The transaction reference numbers are related to each other. The transaction reference numbers (or management numbers) include purchaser purchase order number and purchaser order item number, dealer received order number and dealer received order item number, and supplier invoice number and supplier invoice item number.

When shipment forecast data is received from the supplier, the following is checked: whether the quantity of products ordered by a purchaser agrees with the quantity of products scheduled for shipment, and whether the requested delivery date agrees with the scheduled delivery date. When shipment result data is received from the supplier, the following is checked: whether the purchaser's quantity ordered agrees with the actual quantity shipped, and whether the requested delivery date agrees with the scheduled delivery date. When delivery result data (or delivery received notification) is received from the purchaser, the following is checked: whether the quantity ordered by the purchaser agrees with the actual quantity delivered, and whether the requested delivery date agrees with the actual delivery date. Even if shipment forecast data is not received from the supplier, the following procedure is taken: date-time information is obtained by subtracting a delivery lead time and a shipment forecast lead time from the requested delivery date in the purchaser's ordering data. If the obtained date-time information is delayed from system date-time information in the dealer server, the purchaser is notified that there is the possibility that delayed delivery can occur. Further, the supplier is notified that there is the possibility that delayed delivery can occur and requested to take appropriate measures to prevent such a delay if possible.

Even if shipment result data is not received from the supplier, the following procedure is taken: date-time information is obtained by subtracting a shipment and delivery lead time from the requested delivery date in the purchaser's ordering data. If the obtained date-time information is delayed from system date-time information in the dealer server, the purchaser is swiftly notified that delayed delivery has occurred. Further, the supplier is notified that delayed delivery has occurred and requested to take appropriate measures to resolve this situation.

According to the present embodiment, notification is swiftly made to the parties concerned in the following cases: cases where the quantity ordered disagrees with the quantity delivered; cases where the requested delivery date disagrees with the scheduled delivery date; cases where shipment forecast data is not received by the dealer by the due date; and cases where shipment result data is not received by the dealer by the due date. Thus, with respect to the management of the shipment and delivery of articles of trade, the above-mentioned problems are solved in a timely manner. The items required for shipment and delivery management contained in standard management table data include: product name, purchaser name, point of delivery, supplier name, shipment and delivery lead time, shipment forecast lead time, and the like.

To enable the purchaser, dealer, or supplier to refer to shipment management table data, any of the following is available: purchaser purchase order number and purchaser order item number, dealer purchase order number and dealer order item number, and supplier invoice number and supplier invoice item number. Thus, target data can be retrieved with ease, and this enhances the efficiency of shipping and delivering operations performed by the dealer and between the dealer and the purchaser and supplier.

In addition, according to the present embodiment, standard management table data comprising such items as product name, purchaser name, point of delivery, and supplier name only has to be registered once. Thereafter, each time a transaction is carried out, the dealer's received order data, ordering data, and standard management table data generated are read, and a shipment management table for use in individual transaction management is generated.

In on embodiment, a method for managing product transaction information of a purchaser, dealer, and supplier includes providing a shipment management table on a on storage device of a dealer server, the shipment management table including purchaser transaction reference information, dealer transaction reference information, supplier transaction reference information, product delivery date requested by the purchaser, the scheduled shipping date of the product by the supplier, the requested product delivery date being generated by purchase order information received from the purchaser and the anticipated shipping date being generated by information provided by the supplier; comparing the requested product delivery date and the anticipated shipping by accessing the shipment management table stored in the storage device; determining whether or not the anticipated shipping date satisfies the requested delivery date requested by the purchaser; and transmitting a message notifying at least to one of the purchaser and supplier of a delivery problem if the anticipated shipping date is determined to be unsatisfactory with respect to the requested delivery date, the message being transmitted to a network coupled to the dealer server.

The method further comprises generating a transaction management table relating to a product purchase order involving the purchaser, dealer, and a supplier. The transaction management table includes purchaser information, dealer information, supplier information, shipment-related lead time information, and shipment forecast lead time.

As used herein, the purchaser information refers to information that identifies or is associated with the purchaser. For example, the purchaser information includes the purchaser name and/or identification information thereof. The dealer information refers to information that identifies or is associated with the dealer. For example, the dealer information includes the dealer name and/or identification information thereof. The supplier information refers to information that identifies or is associated with the supplier. For example, the supplier information includes supplier name and/or identification information thereof. The lead time refers to an estimated time it would take to for a given action to be performed.

As used herein, the purchaser transaction reference information refers to purchaser and purchased product as it relates to the purchaser. For example, the purchaser transaction reference information relates to the purchaser identity, purchaser order item number, purchaser order number, or any combination thereof. The dealer transaction reference information relates to information that refers to the dealer and the purchased product as it relates to the dealer. For example, the dealer information includes the dealer identity, dealer received order number, dealer received order item number, dealer purchase order number, dealer item order number, or any combination thereof. The supplier information refers to information that refers to the supplier and the purchased product as it relates to the supplier. For example, the supplier information relates to supplier identity, supplier invoice number, supplier invoice item number, or any combination thereof.

In another embodiment, a dealer server system for managing product transaction information involving a purchaser, dealer, and supplier comprises means for providing a shipment management table on a on storage device of a dealer server, the shipment management table including purchaser transaction reference information, dealer transaction reference information, supplier transaction reference information, product delivery date requested by the purchaser, the scheduled shipping date of the product by the supplier, the requested product delivery date being generated by purchase order information received from the purchaser and the anticipated shipping date being generated by information provided by the supplier; means for comparing the requested product delivery date and the anticipated shipping by accessing the shipment management table stored in the storage device; means for determining whether or not the anticipated shipping date satisfies the requested delivery date requested by the purchaser; and means for transmitting a message notifying at least to one of the purchaser and supplier of a delivery problem if the anticipated shipping date is determined to be unsatisfactory with respect to the requested delivery date, the message being transmitted to a network coupled to the dealer server.

In yet another embodiment, a computer readable medium including a computer program for managing product transaction information of a purchaser, dealer, and supplier is disclosed. The computer program comprises code for providing a shipment management table on a on storage device of a dealer server, the shipment management table including purchaser transaction reference information, dealer transaction reference information, supplier transaction reference information, product delivery date requested by the purchaser, the scheduled shipping date of the product by the supplier, the requested product delivery date being generated by purchase order information received from the purchaser and the anticipated shipping date being generated by information provided by the supplier; code for comparing the requested product delivery date and the anticipated shipping by accessing the shipment management table stored in the storage device; code for determining whether or not the anticipated shipping date satisfies the requested delivery date requested by the purchaser; and code for transmitting a message notifying at least to one of the purchaser and supplier of a delivery problem if the anticipated shipping date is determined to be unsatisfactory with respect to the requested delivery date, the message being transmitted to a network coupled to the dealer server.

In yet another embodiment, a dealer server for managing product transaction information involving a purchaser, dealer, and supplier includes a communication interface to couple the dealer server to a purchaser computer and a supplier computer; a processor to process information; and a storage device to store the product transaction information involving the purchaser, dealer, and supplier. The dealer sever is configured to store a shipment management table on a on storage device of a dealer server, the shipment management table including purchaser transaction reference information, dealer transaction reference information, supplier transaction reference information, product delivery date requested by the purchaser, the scheduled shipping date of the product by the supplier, the requested product delivery date being generated by purchase order information received from the purchaser and the anticipated shipping date being generated by information provided by the supplier. The dealer server compares the requested product delivery date and the anticipated shipping by accessing the shipment management table stored in the storage device, and determines whether or not the anticipated shipping date satisfies the requested delivery date requested by the purchaser, and transmits a message notifying at least to one of the purchaser and supplier of a delivery problem if the anticipated shipping date is determined to be unsatisfactory with respect to the requested delivery date, the message being transmitted to a network coupled to the dealer server.

### BRIEF DESCRIPTION OF THE DRAWINGS

FIG. 1A illustrates a shipment and delivery management system according to an embodiment of the present invention.

FIG. 1B illustrates a plurality of components included in the shipment and delivery management system of FIG. 1A according to one embodiment of the present invention.

FIGS. 2(a) to 2(d) illustrates exemplary tables and set data items stored in the magnetic recorder of the purchaser system according to one embodiment of the present invention.

FIGS. 3(a) to 3(b) illustrates exemplary tables and set data items stored in the magnetic recorder of the dealer system according to one embodiment of the present invention.

FIGS. 4(c) to 4(f) illustrates exemplary tables and set data items stored in the magnetic recorder of the dealer system according to one embodiment of the present invention.

FIGS. 5(g) to 5(j) are drawings illustrating an example of tables and set data items stored in the magnetic recorder of the dealer system in the embodiment of the present invention.

FIGS. 6(k) and 6(l) are drawings illustrating an example of tables and set data items stored in the magnetic recorder of the dealer system in the embodiment of the present invention.

FIGS. 7(a) to 7(d) are drawings illustrating an example of tables and set data items stored in the magnetic recorder of the supplier system in the embodiment of the present invention.

FIG. 8 is a drawing illustrating the flow of shipment and delivery management processing in the embodiment of the present invention.

FIG. 9 is a flowchart illustrating the operation of the standard management table creation processing program in the embodiment of the present invention.

FIG. 10 is a flowchart illustrating the operation of the shipment management table creation processing program in the embodiment of the present invention.

FIG. 11 is a flowchart illustrating the operation of the dealer's received order data creation processing program in the embodiment of the present invention.

FIG. 12 is a flowchart illustrating the operation of the dealer's ordering data creation processing program in the embodiment of the present invention.

FIG. 13 is a flowchart illustrating the operation of the dealer's ordering data transmission processing program in the embodiment of the present invention.

FIG. 14 is a flowchart illustrating the operation of the shipment forecast confirmation processing program in the embodiment of the present invention.

FIG. 15 is a flowchart illustrating the operation of the shipment result confirmation processing program in the embodiment of the present invention.

FIG. 16 is a flowchart illustrating the operation of the delivery result confirmation processing program in the embodiment of the present invention.

FIG. 17 is a flowchart illustrating the operation of the shipment and delivery situation confirmation processing program in the embodiment of the present invention.

FIG. 18 is a flowchart illustrating the operation of the shipment forecast delay notification processing program in the embodiment of the present invention.

FIG. 19 is a flowchart illustrating the operation of the shipment result delay notification processing program in the embodiment of the present invention.

FIGS. 20(m), 20(n), 20(o), and 20(p) are drawings illustrating an example of tables and set data items stored in the magnetic recorder of the dealer system in the embodiment of the present invention.

FIG. 21 is a drawing illustrating the flow of shipment and delivery management processing in the embodiment of the present invention.

### DETAILED DESCRIPTION OF THE INVENTION

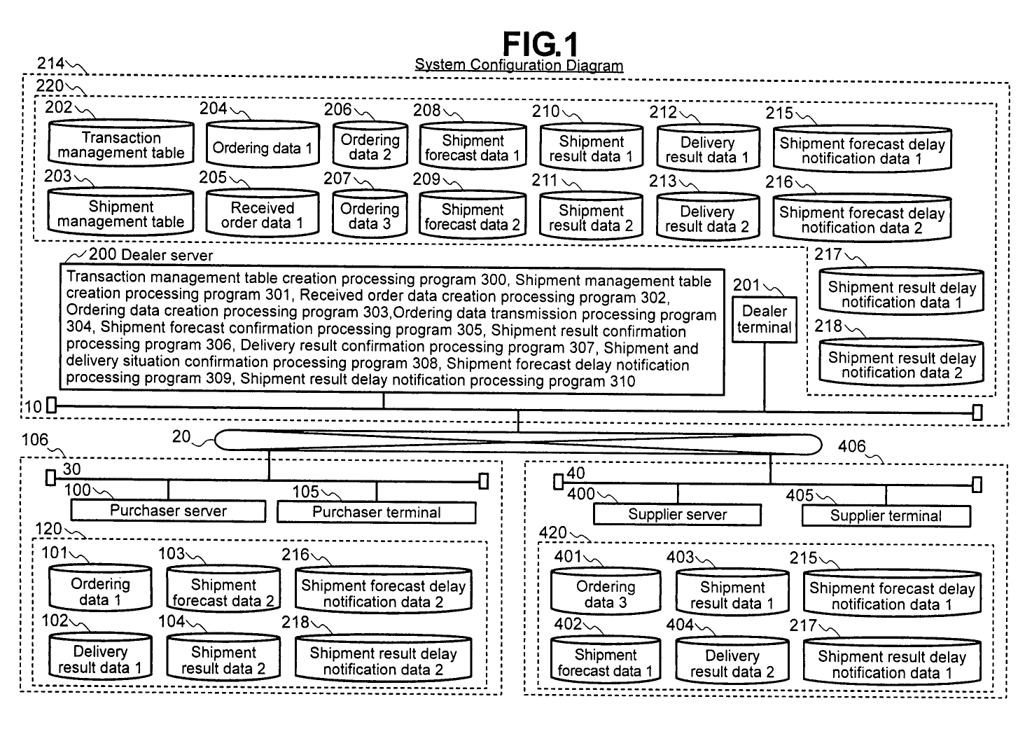

FIG. 1A is a configuration diagram illustrating the configuration of a shipment and delivery management system in an embodiment of the present invention.

In the figure, the shipment and delivery management system comprises a purchaser system 106 for transmitting ordering data and delivery data to the dealer; a supplier system 406 for transmitting shipment forecast data and shipment result data to the dealer; a dealer system 214 which carries out shipment and delivery management based on information from the purchaser system 106 and the supplier system 406. The purchaser system 106, supplier system 406, dealer system 214 are connected with one another by means of communication or the like through a network 20.

The purchaser system 106 and the supplier system 406 are so constituted that one or more of them can respectively connect to one dealer system 214 through the network 20. The dealer system 214 is so constituted that it creates ordering data for a plurality of supplier systems 406 based on ordering data from a plurality of purchaser systems 106.

The purchaser system 106 comprises a purchaser server 100 for performing purchaser data processing and the like; a purchaser terminal 105; and a magnetic recorder 120. The purchaser server 100 and the purchaser terminal device 105 are connected with each other through the purchaser's LAN 30. The magnetic recorder 120 stores ordering data 1 (101), delivery result data 1 (102), shipment forecast data 2 (103), shipment result data 2 (104), shipment forecast delay notification data 2 (216), and shipment result delay notification data 2 (218). The magnetic recorder 120 may be other types of storage devices.

The supplier system 406 comprises a supplier server 400 for performing data processing and the like processing on the supplier side; a supplier terminal 405; and a magnetic recorder 420. The supplier server 400 and the supplier terminal 405 are connected with each other through the supplier's LAN 40.

The magnetic recorder 420 stores ordering data 3 (401), shipment forecast data 1 (402), shipment result data 1 (403), delivery result data 2 (404), shipment forecast delay notification data 1 (215), and shipment result delay notification data 1 (217). The shipment forecast data 1 (402), shipment result data 1 (403), and delivery result data 2 (404) constitute shipment and delivery data the magnetic recorder 420 may be other types of storage devices.

The dealer system 214 comprise a dealer server 200 which is a control means for performing shipment and delivery management and the like processing on the dealer side; a dealer terminal 201; and a magnetic recorder 220. The dealer server 200 and the dealer terminal 201 are connected with each other through the dealer's LAN 10. The magnetic recorder 220 may be other types of storage devices.

The following programs run on the dealer server 200: a transaction management table creation processing program 300 as transaction management table generating means; a shipment management table creation processing program 301 as shipment management table generating means; a received order data creation processing program 302; an ordering data creation processing program 303; an ordering data transmission processing program 304; a shipment forecast confirmation processing program 305 as shipment forecast confirmation processing means; a shipment result confirmation processing program 306 as shipment result confirmation processing means; a delivery result confirmation processing program 307 as delivery result confirmation processing means; a shipment and delivery situation confirmation processing program 308 as shipment and delivery situation confirmation processing means; a shipment forecast delay notification processing program 309; and a shipment result delay notification processing program 310.

The following shipment and delivery processing is carried out by these programs: received order data creation processing wherein purchase orders received from the purchaser server 100 are used; supplier-destined ordering data creation processing and transmission processing to the supplier server 400 wherein received order data is used; purchaser-destined shipment forecast data creation processing and transmission processing to the purchaser server 100 wherein shipment forecast data received from the supplier server 400 is used; purchaser-destined shipment result data creation processing and transmission processing to the purchaser server 100 wherein shipment result data received from the supplier server 400 is used; supplier-destined delivery result data creation processing and transmission processing to the supplier server 400 wherein delivery result data received from the purchaser server 100 is used; and the like processing.

The magnetic recorder 220 stores transaction management table data 202, shipment management table data 203, ordering data 1 (204), received order data 1 (205), ordering data 2 (206), ordering data 3 (207), shipment forecast data (208), shipment forecast data 2 (209), shipment result data 1 (210), shipment result data 2 (211), delivery result data 1 (212), delivery result data 2 (213), shipment forecast delay notification data 1 (215), shipment forecast delay notification data 2 (216), shipment result delay notification data 1 (217), and shipment result delay notification data 2 (218).

Next, description will be given to examples of the tables stored in the magnetic recorder 120 of the purchaser system 106, the magnetic recorder 220 of the dealer system 214, and the magnetic recorder 420 of the supplier system 406, and data sets.

FIG. 1B illustrate some of the components included in the shipment and delivery management system of FIG. 1A according to one implementation. The dealer system 214 includes a first magnetic recorder 252 to store table and data, a second magnetic recorder 254 to store programs, a server 200, a dealer terminal. The first and second magnetic recorders may be other types of storage devices, including semiconductor devices. The server 200 includes a memory, a processor, and an interface. The dealer terminal includes a memory, a processor, and an interface as well. Similarly, the purchaser system 106 includes a server 100, a terminal 105, and a storage device 120. The supplier system 406 includes a server 400, a terminal 405, and a storage device 420.

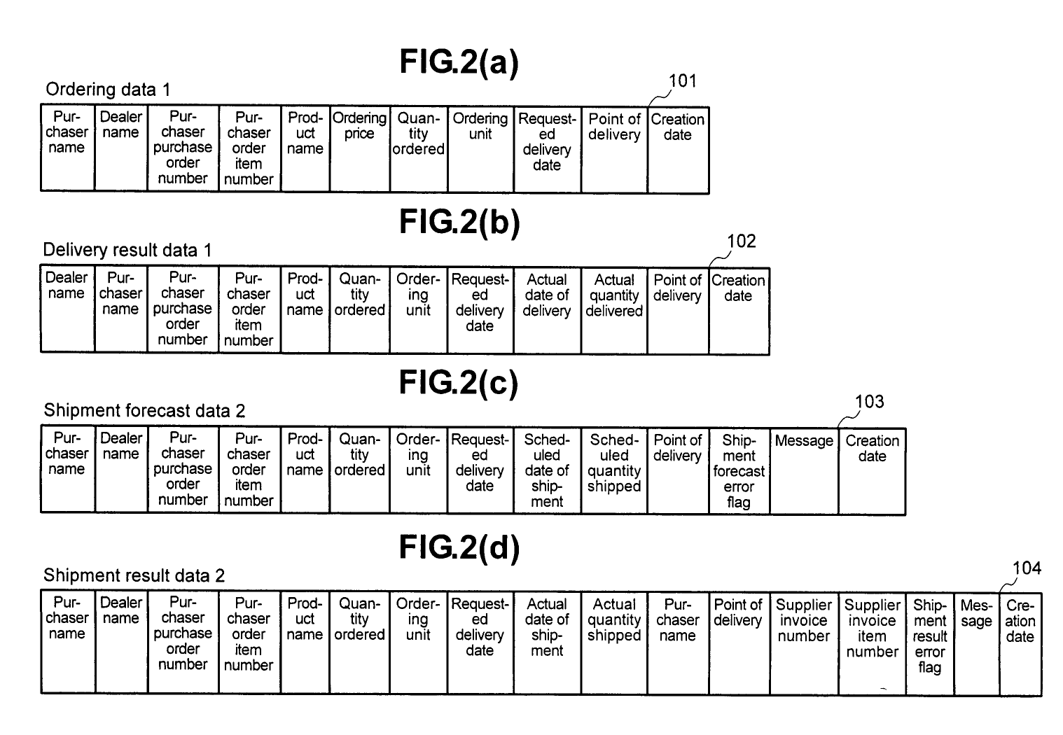

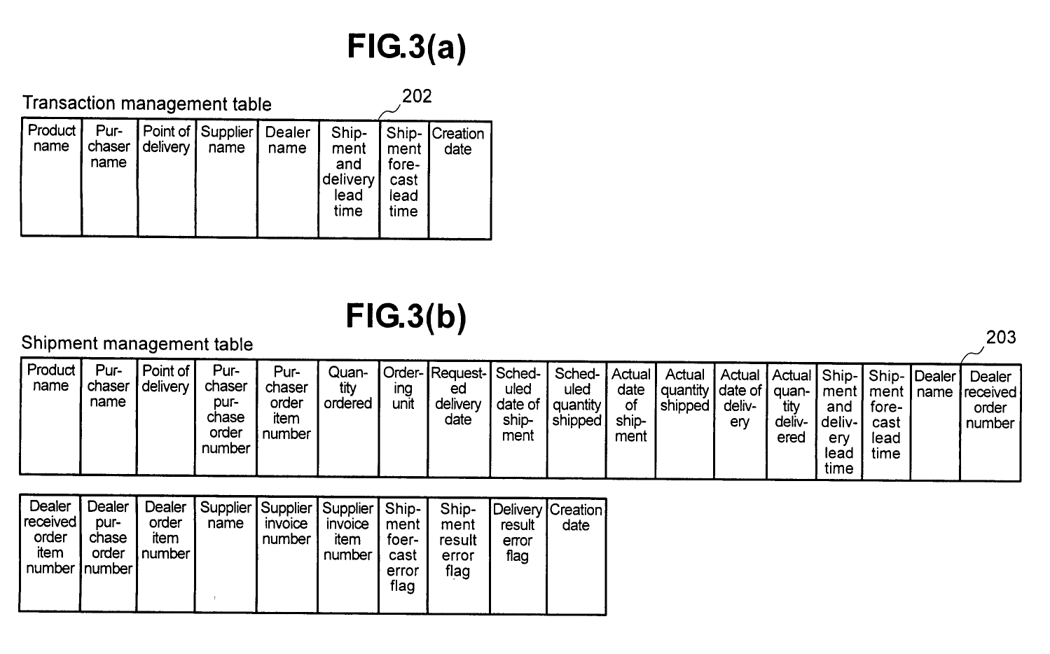

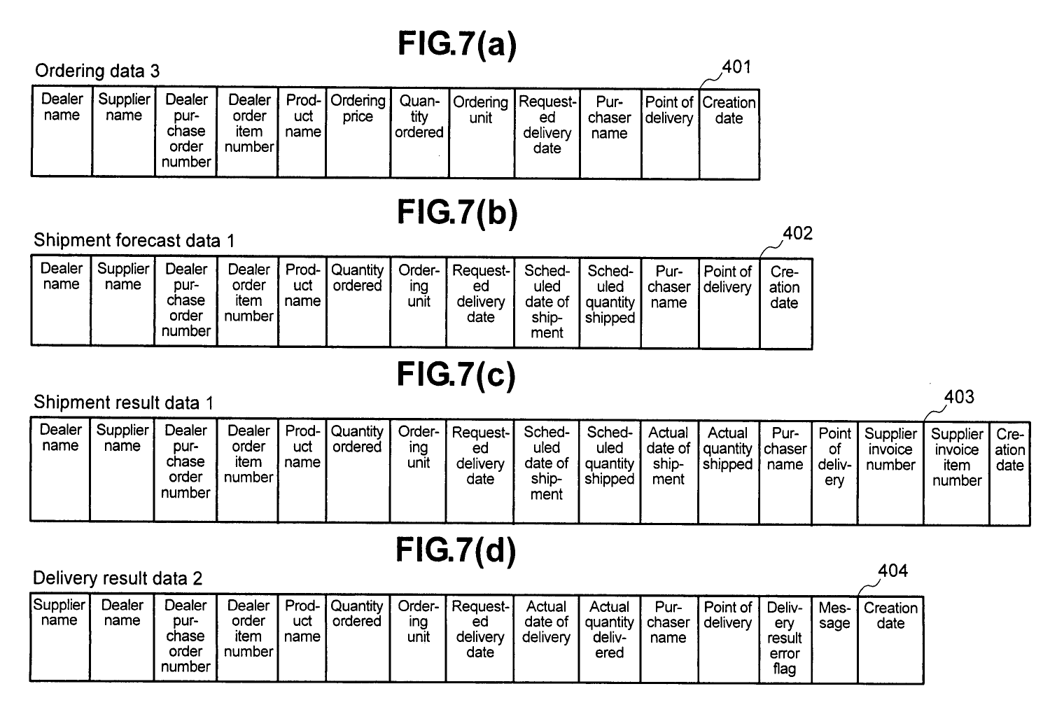

FIGS. 2(a) to 2(d) are drawings illustrating examples of data sets for the data stored in the magnetic recorder 120 of the purchaser system 106. FIGS. 3(a) and 3(b), FIGS. 4(c) to 4(f), FIGS. 5(g) to 5(j), and FIGS. 6(k) and 6(l) are drawings illustrating examples of tables stored in the magnetic recorder 220 of the dealer system 214 and data sets for the data. FIGS. 7(a) to 7(d) are drawings illustrating examples of data sets for the data stored in the magnetic recorder 420 of the supplier system 406.

First, description will be given to data stored in the magnetic recorder 120 of the purchaser system 106. As illustrated in FIG. 2(a), the following items comprise ordering data 1 (101): purchaser name, dealer name, purchaser purchase order number, purchaser order item number, product name, ordering price, quantity ordered, ordering unit, requested delivery date, point of delivery, and creation date.

As illustrated in FIG. 2(b), the following items comprise delivery result data 1 (102): dealer name, purchaser name, purchaser purchase order number, purchaser order item number, product name, quantity ordered, ordering unit, requested delivery date, actual delivery date, actual quantity delivered, point of delivery, and creation date.

As illustrated in FIG. 2(c), the following items comprise shipment forecast data 2 (103): purchaser name, dealer name, purchaser purchase order number, purchaser order item number, product name, quantity ordered, ordering unit, requested delivery date, scheduled date of shipment, scheduled quantity shipped, point of delivery, shipment forecast error flag, message, and creation date. As illustrated in FIG. 2(d), the following items comprise shipment result data 2 (104): purchaser name, dealer name, purchaser purchase order number, purchaser order item number, product name, quantity ordered, ordering unit, requested delivery date, actual date of shipment, actual quantity shipped, point of delivery, supplier name, supplier invoice number, supplier invoice item number, shipment result error flag, message, and creation date.

Next, description will be given to tables and data stored in the magnetic recorder 220 of the dealer system 214. As illustrated in FIG. 3(a), the following items comprise transaction management table data 202: product name, purchaser name, point of delivery, supplier name, dealer name, shipment and delivery lead time, shipment forecast lead time, and creation date. As illustrated in FIG. 3(b), the following items comprise shipment management table data 203: product name, purchaser name, point of delivery, purchaser purchase order number, purchaser order item number, quantity ordered, ordering unit, requested delivery date, scheduled date of shipment, scheduled quantity shipped, actual date of shipment, actual quantity shipped, actual delivery date, actual quantity delivered, shipment and delivery lead time, shipment forecast lead time, dealer name, dealer received order number, dealer received order item number, dealer purchase order number, dealer order item number, supplier name, supplier invoice number, supplier invoice item number, shipment forecast error flag, shipment result error flag, delivery result error flag, and creation date.

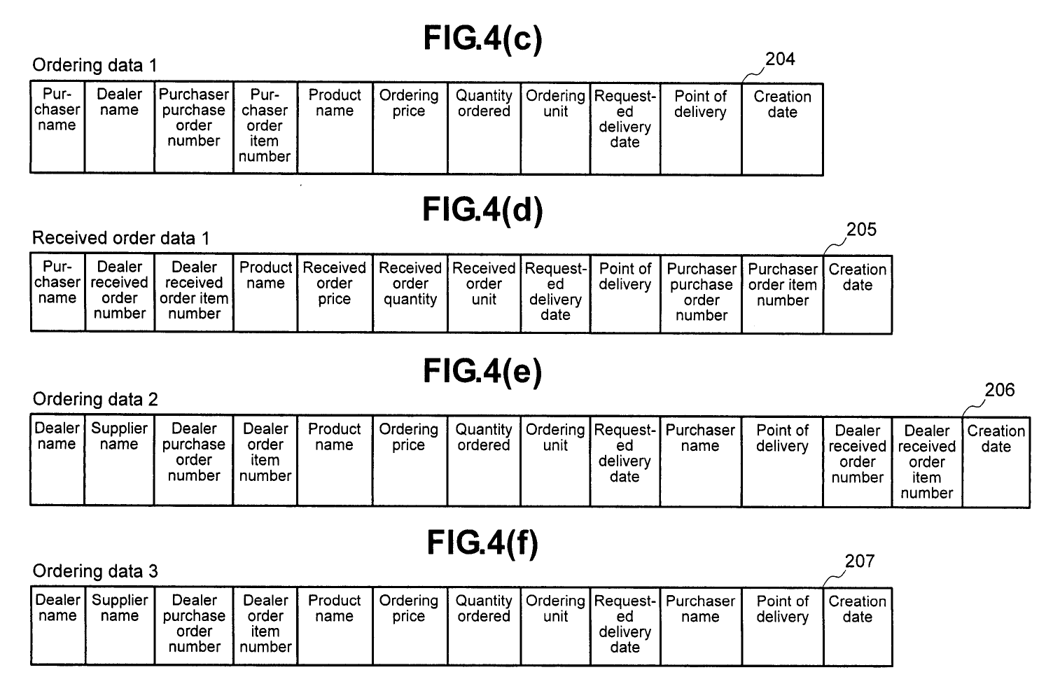

As illustrated in FIG. 4(c), the following items comprise ordering data 1 (204): purchaser name, dealer name, purchaser purchase order number, purchaser order item number, product name, ordering price, quantity ordered, ordering unit, requested delivery date, point of delivery, and creation date.

As illustrated in FIG. 4(d), the following items comprise received order data 1 (205): purchaser name, dealer received order number, dealer received order item number, product name, received order price, received order quantity, received order unit, requested delivery date, point of delivery, purchaser purchase order number, purchaser order item number, and creation date.

As illustrated in FIG. 4(e), the following items comprise ordering data 2 (206): dealer name, supplier name, dealer purchase order number, dealer order item number, product name, ordering price, quantity ordered, ordering unit, requested delivery date, purchaser name, point of delivery, dealer received order number, dealer received order item number, and creation date. As illustrated in FIG. 4(f), the following items comprise ordering data 3 (207): dealer name, supplier name, dealer purchase order number, dealer order item number, product name, ordering price, quantity ordered, ordering unit, requested delivery date, purchaser name, point of delivery, and creation date.

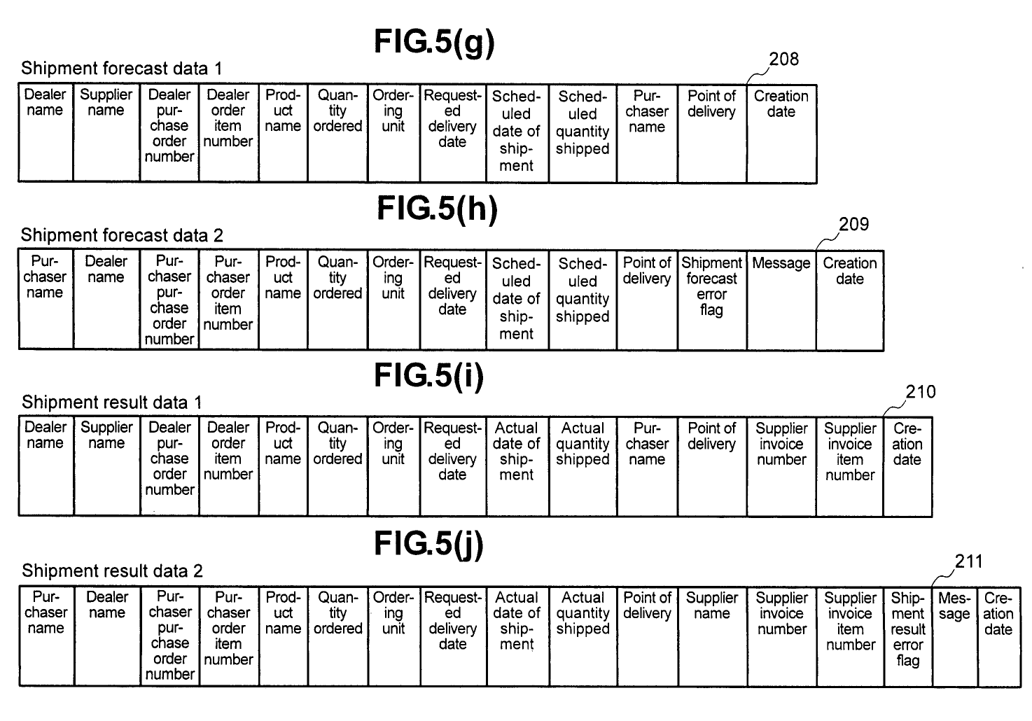

As illustrated in FIG. 5(g), the following items comprise shipment forecast data 1 (208): dealer name, supplier name, dealer purchase order number, dealer order item number, product name, quantity ordered, ordering unit, requested delivery date, scheduled date of shipment, scheduled quantity shipped, purchaser name, point of delivery, and creation date. As illustrated in FIG. 5(h), the following items comprise shipment forecast data 2 (209): purchaser name, dealer name, purchaser purchase order number, purchaser order item number, product name, quantity ordered, ordering unit, requested delivery date, scheduled date of shipment, scheduled quantity shipped, point of delivery, shipment forecast error flag, message, and creation date. As illustrated in FIG. 5(i), the following items comprise shipment result data 1 (210): dealer name, supplier name, dealer purchase order number, dealer order item number, product name, quantity ordered, ordering unit, requested delivery date, actual date of shipment, actual quantity shipped, purchaser name, point of delivery, supplier invoice number, supplier invoice item number, and creation date. As illustrated in FIG. 5(j), the following items comprise shipment result data 2 (211): purchaser name, dealer name, purchaser purchase order number, purchaser order item number, product name, quantity ordered, ordering unit, requested delivery date, actual date of shipment, actual quantity shipped, point of delivery, supplier name, supplier invoice number, supplier invoice item number, shipment result error flag, message, and creation date.

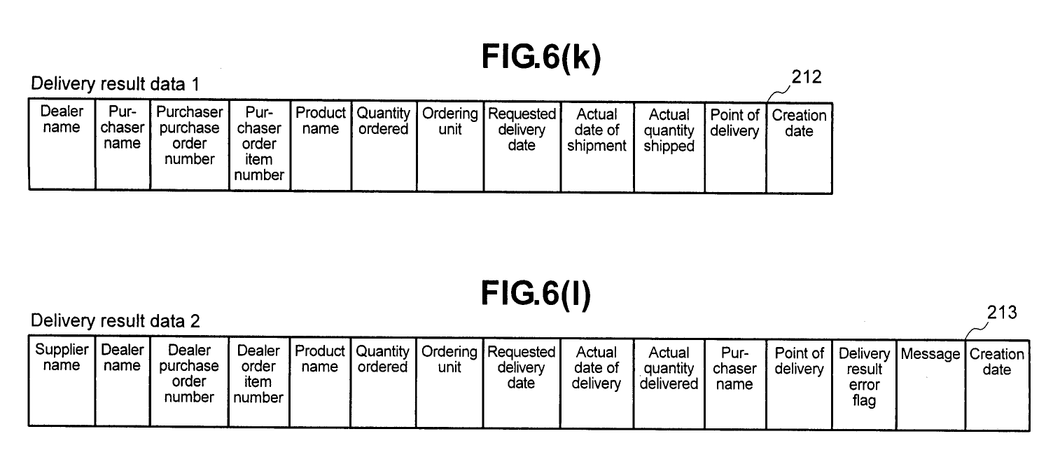

As illustrated in FIG. 6(k), the following items comprise delivery result data 1 (212): dealer name, purchaser name, purchaser purchase order number, purchaser order item number, product name, quantity ordered, ordering unit, requested delivery date, actual date of shipment, actual quantity shipped, point of delivery, and creation date. As illustrated in FIG. 6(l), the following items comprise delivery result data 2 (213): supplier name, dealer name, dealer purchase order number, dealer order item number, product name, quantity ordered, ordering unit, requested delivery date, actual delivery date, actual quantity delivered, purchaser name, point of delivery, delivery result error flag, message, and creation date.

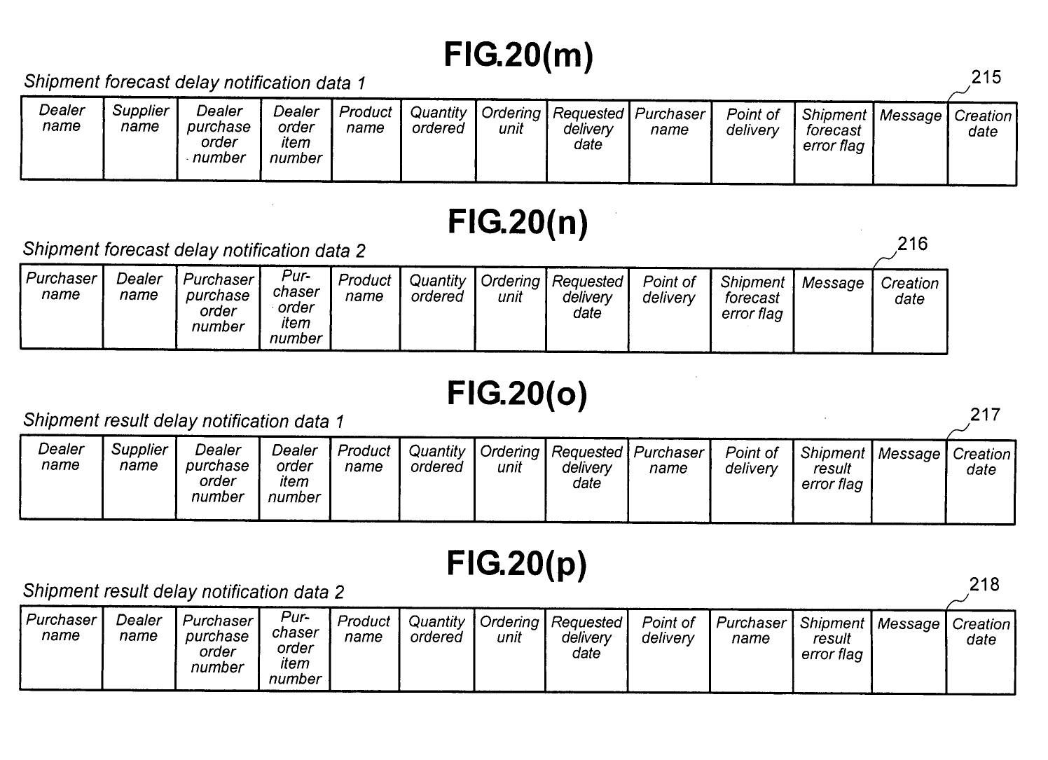

As illustrated in FIG. 20(m), the following items comprise shipment forecast delay notification data 1 (215): dealer name, supplier name, dealer purchase order number, dealer order item number, product name, quantity ordered, ordering unit, requested delivery date, purchaser name, point of delivery, shipment forecast error flag, message, and creation date. As illustrated in FIG. 20(n), the following items comprise shipment forecast delay notification data 2 (216): purchaser name, dealer name, purchaser purchase order number, purchaser order item number, product name, quantity ordered, ordering unit, requested delivery date, point of delivery, shipment forecast error flag, message, and creation date.

As illustrated in FIG. 20(o), the following items comprise shipment result delay notification data 1 (217): dealer name, supplier name, dealer purchase order number, dealer order item number, product name, quantity ordered, ordering unit, requested delivery date, point of delivery, shipment result error flag, message, and creation date. As illustrated in FIG. 20(p), the following items comprise shipment result delay notification data 2 (218): purchaser name, dealer name, purchaser purchase order number, purchaser order item number, product name, quantity ordered, ordering unit, requested delivery date, purchaser name, point of delivery, shipment result error flag, message, and creation date.

Next, description will be given to data stored in the magnetic recorder 420 of the supplier system 406. As illustrated in FIG. 7(a), the following items comprise ordering data 3 (401): dealer name, supplier name, dealer purchase order number, dealer order item number, product name, ordering price, quantity ordered, ordering unit, requested delivery date, purchaser name, point of delivery, and creation date.

As illustrated in FIG. 7(b), the following items comprise shipment forecast data 1 (402): dealer name, supplier name, dealer purchase order number, dealer order item number, product name, quantity ordered, ordering unit, requested delivery date, scheduled date of shipment, scheduled quantity shipped, purchaser name, point of delivery, and creation date. As illustrated in FIG. 7(c), the following items comprise shipment result data 1 (403): dealer name, supplier name, dealer purchase order number, dealer order item number, product name, quantity ordered, ordering unit, requested delivery date, actual date of shipment, actual quantity shipped, purchaser name, point of delivery, supplier invoice number, supplier invoice item number, and creation date. As illustrated in FIG. 7(d), the following items comprise delivery result data 2 (404): supplier name, dealer name, dealer purchase order number, dealer order item number, product name, quantity ordered, ordering unit, requested delivery date, actual delivery date, actual quantity delivered, purchaser name, point of delivery, delivery result error flag, message, and creation date.

The tables and the set data items illustrated in FIG. 2(a) to FIG. 7(d) are examples of the tables and data used in this embodiment. The data items are not limited to the above-mentioned items, and any table or data may be used as long as the items in it allow shipment and delivery management amongst the purchaser, dealer, and supplier. The product name item is generally a name that permits the purchaser, dealer, and supplier to identify articles of trade. Other types of product names may be used; e.g., a code number unique to each article of trade which identifies the article of trade.

For the purchaser name, dealer name, and supplier name, proper names or code numbers or the like may be used. For the shipment and delivery lead time, a time from shipment from the supplier to delivery to the purchaser is set beforehand with respect to each article of trade.

For example, data of one day is stored for domestic suppliers, and data of one week to 10 days is stored for overseas suppliers.

For the shipment forecast lead time, a time by which the supplier should give shipment forecast to the dealer prior to actual date of shipment is set beforehand with respect to each article of trade.

For example, if 24 hours is generally required to send an actual shipment notification to a dealer by a supplier from the time the supplier receives the order from the dealer, 24 hours is set for the item shipment forecast lead time.

Next, the operation of this embodiment will be described.

First, description will be given to data exchanged between the purchaser server 100, dealer server 200, and supplier server 400 in this embodiment. Further, description will be given to the flow of shipment and delivery management carried out by the dealer server 200 using the data.

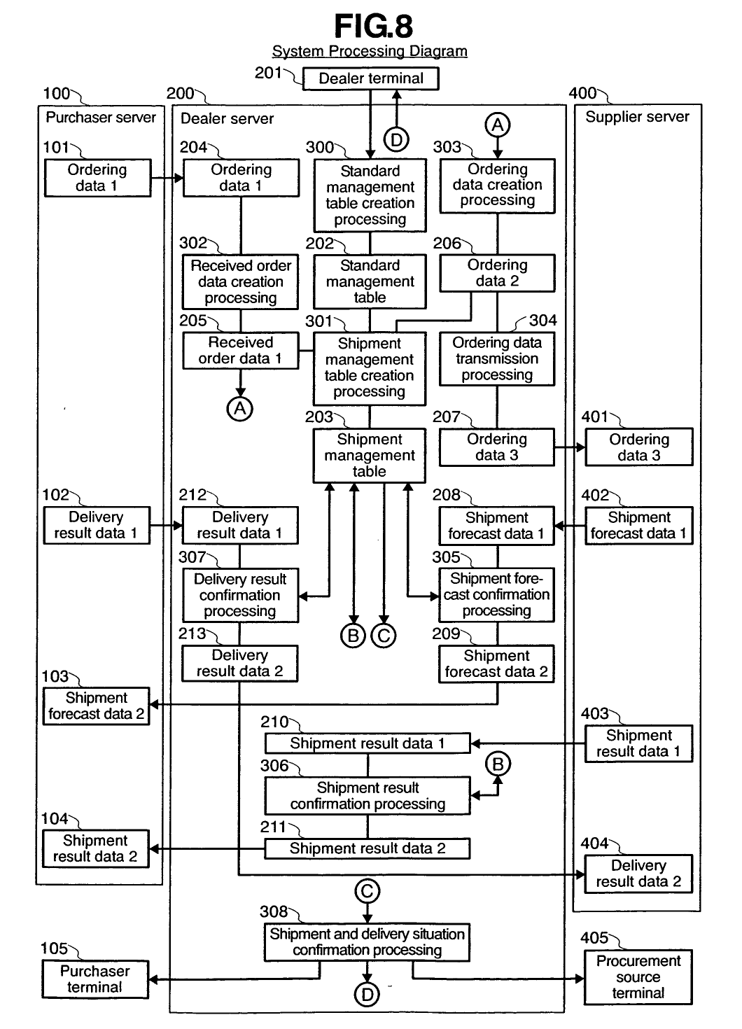

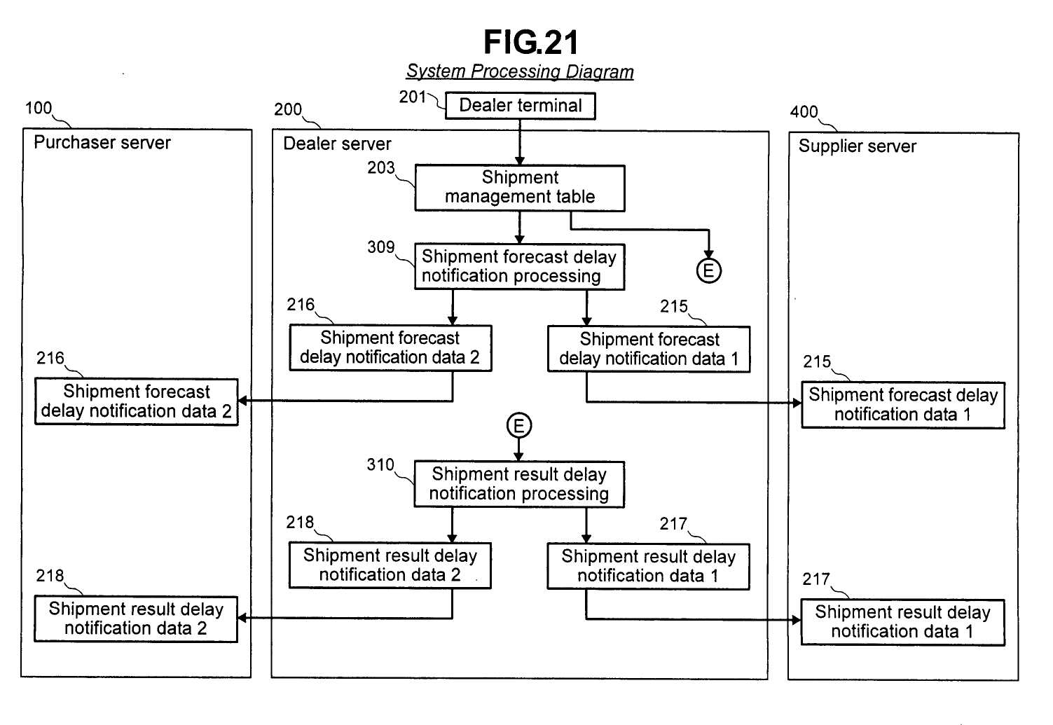

FIG. 8 and FIG. 21 are drawings illustrating the flow of shipment and delivery management in this embodiment. First, ordering data 1 (101) related to an article of trade (e.g., a computer) purchased by the purchaser is transmitted from the purchaser server 100 to the dealer server 200. At the dealer server 200, received order data 1 (205) is created from the received order data 1 (204) by the received order data creation processing program 302.

Then, ordering data 2 (206) is created from the received order data 1 (205) by the ordering data creation processing program 303. Ordering data 3 (207) to be transmitted to the supplier is created from the ordering data 2 (206) by the ordering data transmission processing program 304. The created ordering data is transmitted to the supplier server 400. If a connection with a new purchaser or supplier is formed with respect to a new article of trade or an existing article of trade, the dealer takes the following procedure: at the dealer terminal 201, the dealer inputs information to be established in the transaction management table 202. Thus, transaction management table data 202 which indicates the relation between the article of trade and the purchaser, dealer, and supplier is created from the inputted information. This is done by the transaction management table creation processing program.

Then, shipment management table data 203 is created from the received order data 1 (205), ordering data 2 (206), and transaction management table data 202 by the shipment management table creation processing program 301. The supplier server 400 performs order processing or shipment processing based on the ordering data 3 (207). First, shipment forecast data 1 (402) is transmitted to the dealer server 200, and at the dealer server 200, shipment forecast data 2 (209) is created from the received shipment forecast data 1 (208) and shipment management table data 203. This is done by the shipment forecast confirmation processing program 305, and the created data is transmitted to the purchaser server 100.

After the article of trade is shipped from the supplier, shipment result data 1 (403) is transmitted from the supplier server 400 to the dealer server 200 to notify the shipment of the article of trade. At the dealer server 200, shipment result data 2 (211) is created from the received shipment result data 1 (201) and the shipment management table data 203. This is done by the shipment result confirmation processing program 306, and the created data is transmitted to the purchaser server 100.

After the article of trade is recieved by the purchaser, delivery result data 1 (102) is transmitted from the purchaser server 100 to the dealer server 200. At the dealer server 200, delivery result data 2 (213) is created from the received delivery result data 1 (212) and the shipment management table data 203. This is done by the delivery result confirmation processing program 307, and the created data is transmitted to the purchaser server 100.

The purchase order numbers, order item numbers, invoice numbers, invoice item numbers, and the like used by the purchaser, dealer, and supplier comprise the shipment management table data 203. A reference key, such as purchase order number, used by the purchaser, dealer, or supplier, is inputted at the purchaser terminal 105, dealer terminal 201, or supplier terminal 405. Based on the information of the reference key, information contained in the shipment management table data 203 is transmitted to the purchaser terminal 105, dealer terminal 201, or supplier terminal 405 and is displayed there. This is done by the shipment and delivery situation confirmation processing program 308.

If the dealer does not receive shipment forecast data from the supplier at the dealer server in a predetermined period, shipment delay notification data 2 (216) destined for the purchaser and shipment delay notification data 1 (215) destined for the supplier are created. The created pieces of data are respectively transmitted to the purchaser server and the supplier server to inform of the possible or likely delay. The above processing is performed by the shipment forecast delay notification processing program 309.

If the dealer does not receive shipment result data from the supplier at the dealer server in a predetermined period, shipment result delay notification data 2 (218) destined for the purchaser and shipment result delay notification data 1 (217) destined for the supplier are created. These data are respectively transmitted to the purchaser server and the supplier server to inform these parties of possible delivery problem. The above processing is performed by the shipment result delay notification processing program 310.

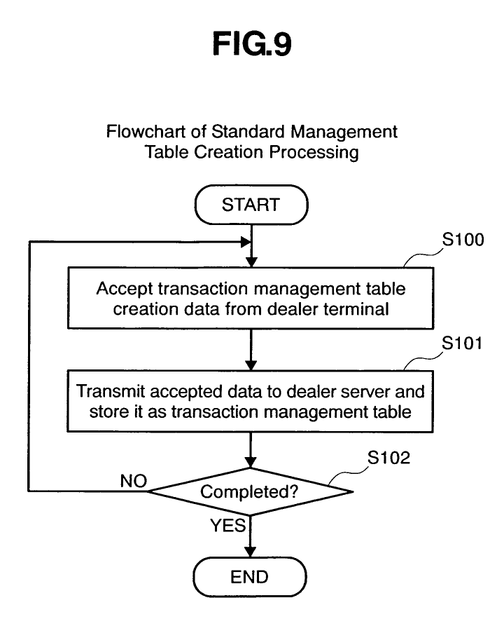

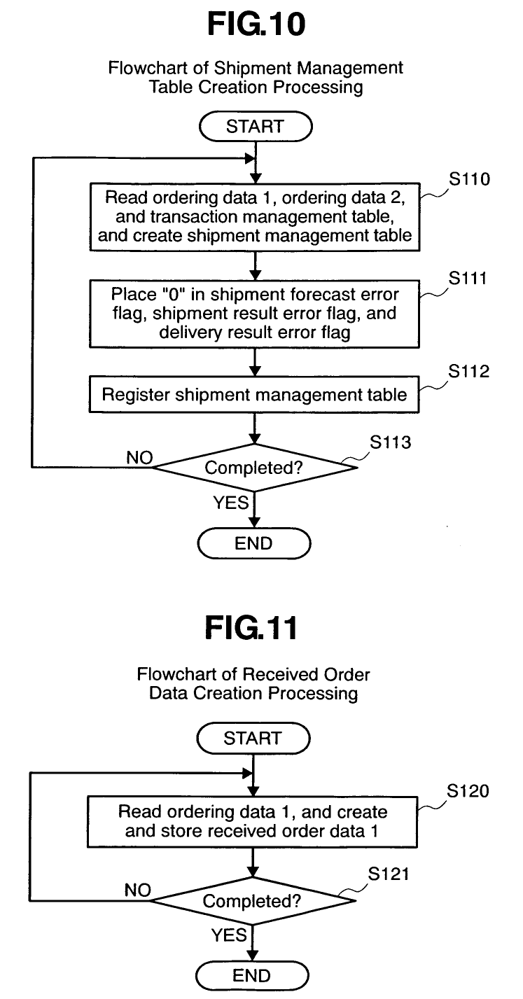

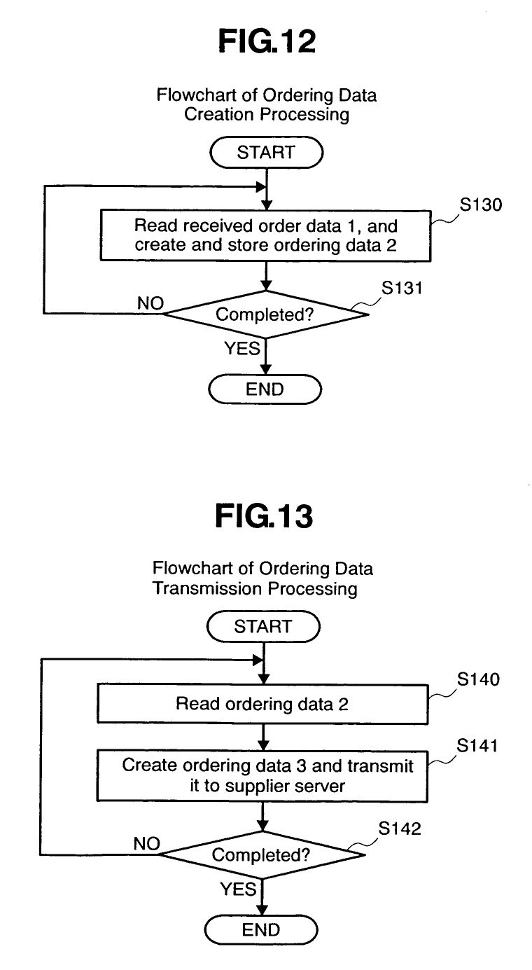

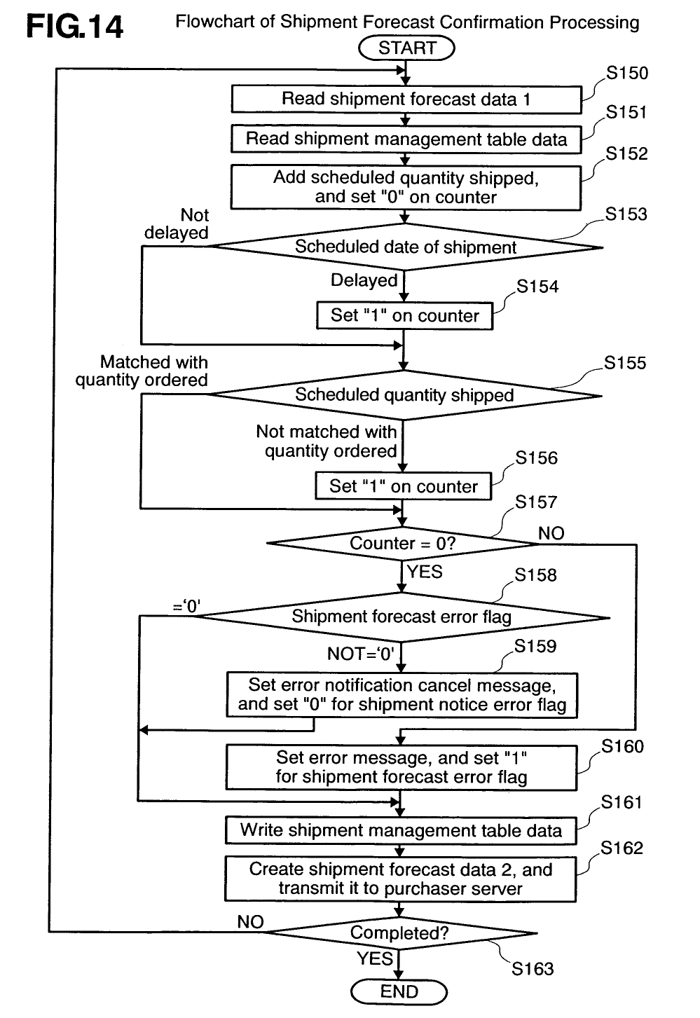

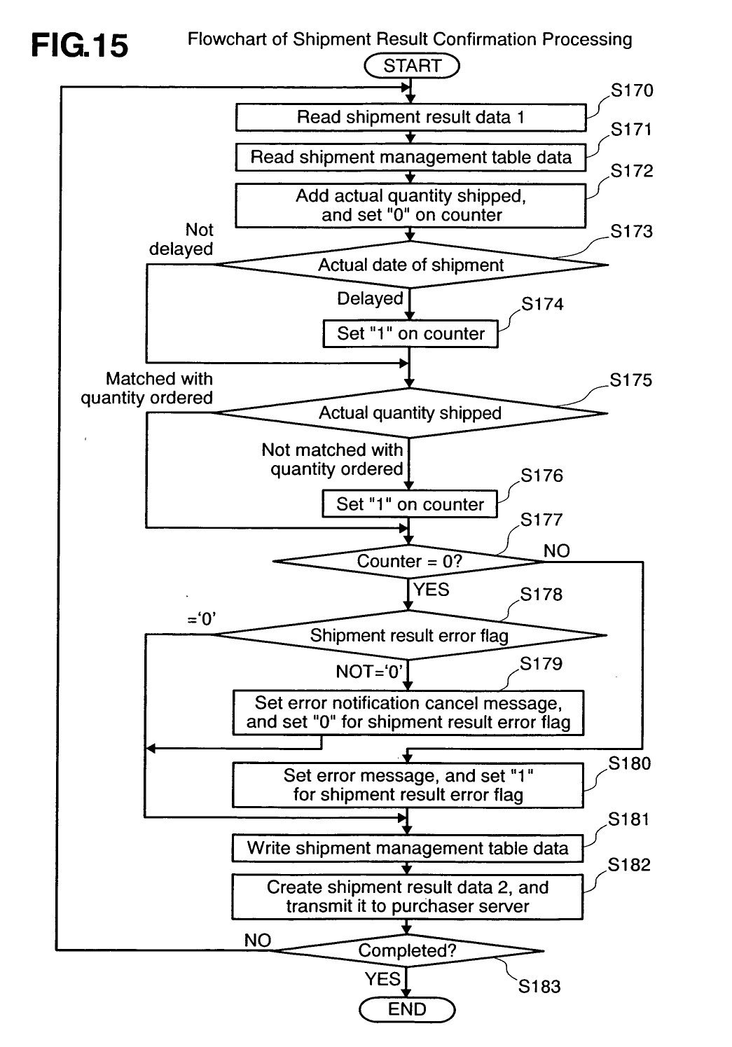

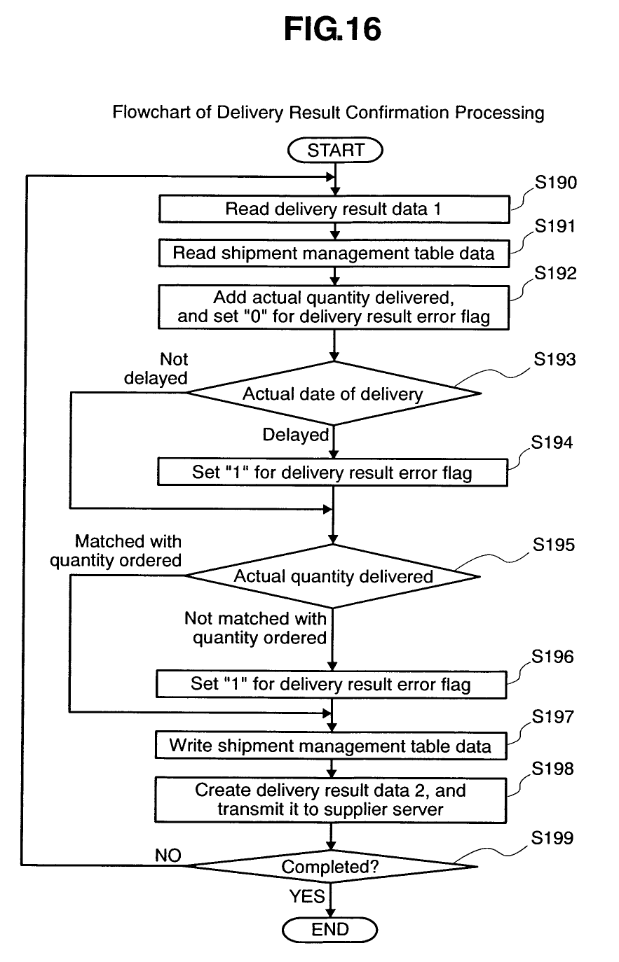

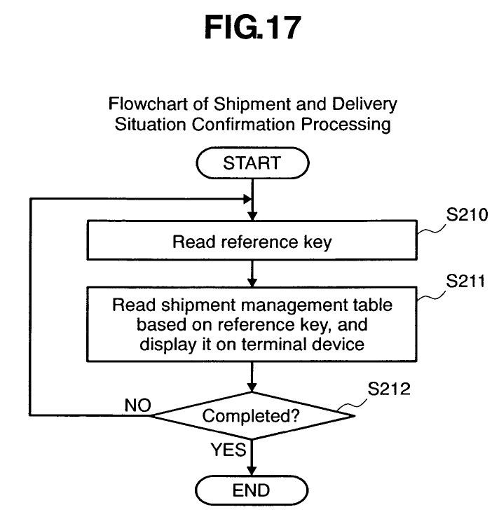

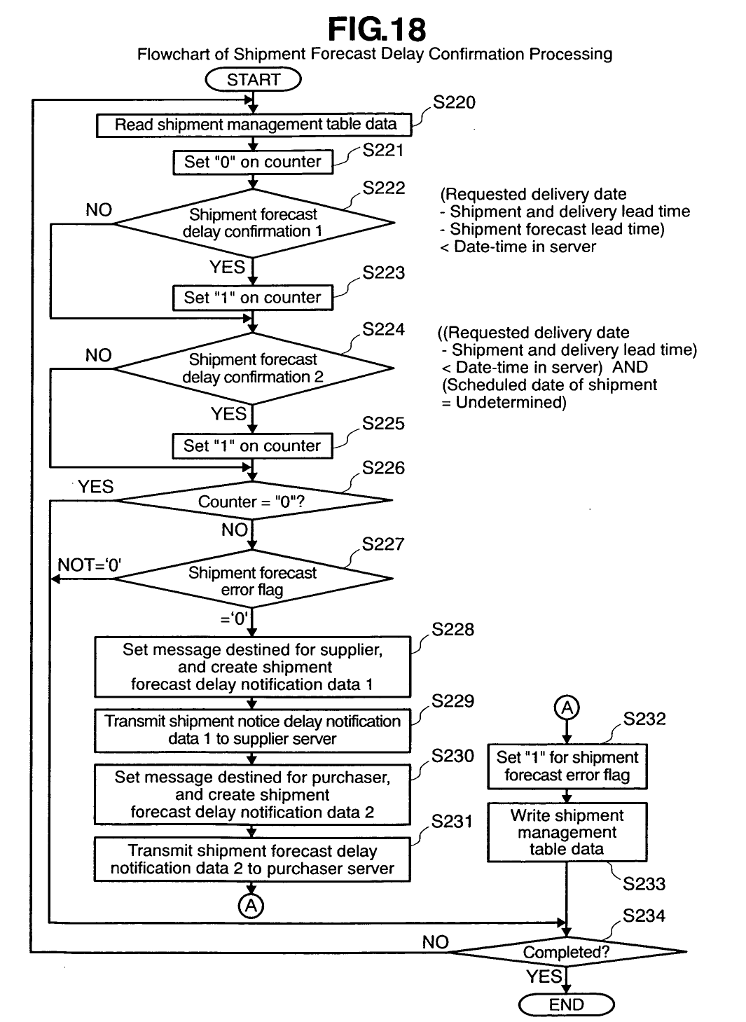

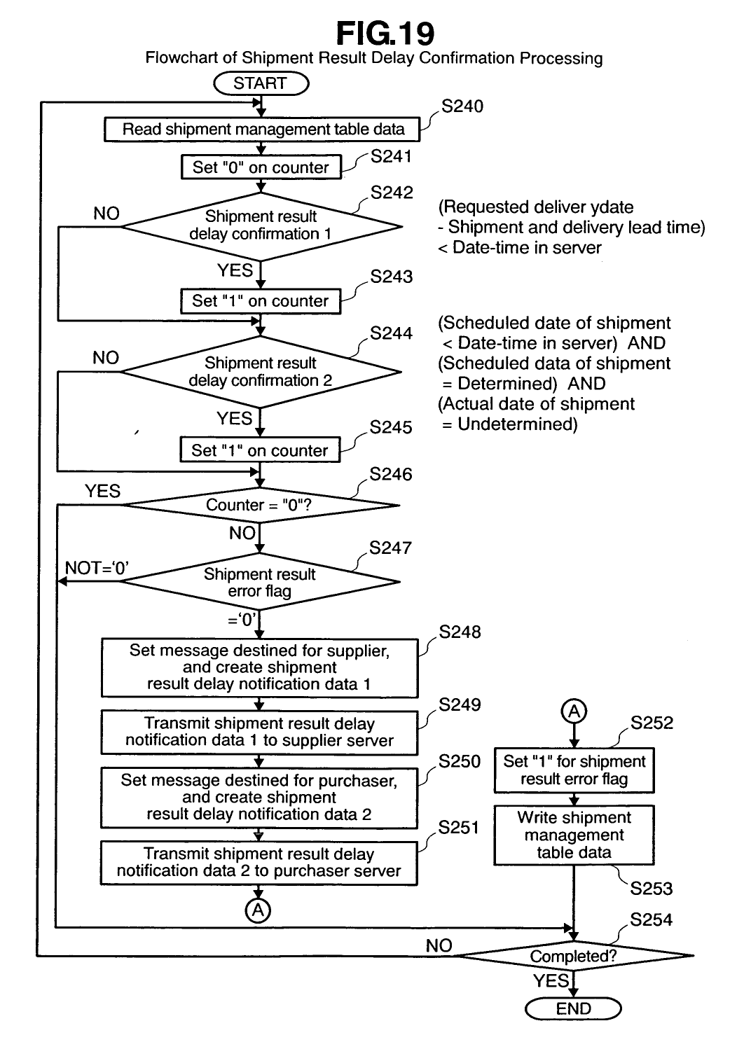

Next, description will be given to the operation of each program in the dealer server 200 in this embodiment. FIG. 9 is a flowchart illustrating the operation of the transaction management table creation processing program 300. FIG. 10 is a flowchart illustrating the operation of the shipment management table creation processing program 301. FIG. 11 is a flowchart illustrating the operation of the received order data creation processing program 302. FIG. 12 is a flowchart illustrating the operation of the ordering data creation processing program 303. FIG. 13 is a flowchart illustrating the operation of the ordering data transmission processing program 304. FIG. 14 is a flowchart illustrating the operation of the shipment forecast confirmation processing program 305. FIG. 15 is a flowchart illustrating the operation of the shipment and delivery situation confirmation processing program 306. FIG. 16 is a flowchart illustrating the operation of the delivery result confirmation processing program 307. FIG. 17 is a flowchart illustrating the operation of the shipment and delivery situation confirmation processing program 308. FIG. 18 is a flowchart illustrating the operation of the shipment forecast delay notification processing program 309. FIG. 19 is a flowchart illustrating the operation of the shipment result delay notification processing program 310.

First, the transaction management table creation processing program 300 accepts a product name, purchaser name, point of delivery, supplier name, dealer name, and shipment and delivery lead time from the dealer terminal 201 (S100). Then, the program 300 stores the data obtained from the dealer terminal 201 in the magnetic recorder 220 as transaction management table data 202 (S101).

Then, the program 300 confirms whether the dealer completes data entry (S102). The program 300 repeats the processing of Steps 100 and 101 until it determines at Step 102 that the data entry has been completed. If the program 300 determines at Step 102 that the data entry has been completed, it terminates the processing. The shipment management table creation processing program 301 reads received order data 1 (205), ordering data 2 (206), and transaction management table data 202. The program 301 sets the following items (S110): product name, purchaser name, point of delivery, purchaser purchase order number, purchaser order item number, quantity ordered, ordering unit, requested delivery date, dealer name, dealer received order number, dealer received order item number, dealer purchase order number, dealer order item number, shipment and delivery lead time, and shipment forecast lead time. The program 301 places “0” in the shipment forecast error flag, shipment result error flag, and delivery result error flag (S111), and stores the created shipment management table data 203 in the magnetic recorder 220 (S112).

The program 301 determines whether processing of the received order data 1 (205) and the ordering data 2 (206) has been all completed (S113). The program 301 repeats the processing of Steps 110 to 112 until it determines at Step 113 that the processing has been completed. If the program 301 determines at Step 113 that the processing has been completed, it terminates the processing. The received order data creation processing program 302 reads ordering data 1 (204), and sets the following items: purchaser name, dealer received order number, dealer received order item number, product name, received order price, received order quantity, received order unit, requested delivery date, point of delivery, purchaser purchase order number, purchaser order item number, and the like. Thereby, the program 302 creates received order data 1 (205), and stores it in the magnetic recorder 220 (S120).

Then, the program 302 determines whether processing of the ordering data 1 (204) has been completed (S121). The program 302 performs the processing of Step 120 until it determines at Step 121 that the processing has been completed. If the program 302 determines at Step 121 that the processing has been completed, it terminates the processing.

The ordering data creation processing program 303 reads received order data 1 (205), and sets the following items: product name, quantity ordered, ordering unit, requested delivery date, purchaser name, point of delivery, dealer received order number, dealer received order item number, and the like. The program 303 adds dealer name, supplier name, dealer purchase order number, dealer order item number to the data to create ordering data 2 (206). It stores the created data in the magnetic recorder 220 (S130).

Then, the program 303 determines whether processing of the received order data 1 (205) has been completed (S131). The program 303 performs the processing of Step 130 until it determines at Step 131 that the processing has been completed. If the program 303 determines at Step 131 that the processing has been completed, it terminates the processing.

The ordering data transmission processing program 304 sets the following items for ordering data 2 (206) read in: dealer name, supplier name, dealer purchase order number, dealer order item number, product name, ordering price, quantity ordered, ordering unit, requested delivery date, purchaser name, point of delivery, and the like. The program 304 thereby creates ordering data 3 (207), and transmits the ordering data 3 (207) to the supplier server 400 (S141).

Then, the program 304 determines whether processing of the ordering data 2 (206) has been completed (S142). The program 304 repeats the processing of Steps 140 and 141 until it determines at Step 142 that the processing has been completed. If the program 304 determines at Step 142 that the processing has been completed, it terminates the processing. The shipment forecast confirmation processing program 305 reads shipment forecast data 1 (208) (S150) that provides information about the product about to be shipped. Subsequently, it reads shipment management table data 203, using as keys the dealer name, dealer purchase order number, dealer order item number, and the like (S151).

Then, the program 305 adds the scheduled quantity shipped in the shipment forecast data 1 (208) to the scheduled quantity shipped in the shipment management table data 203. It sets “0” on the counter (counter clear processing) (S152).

Then, the program 305 adds the shipment and delivery lead time in the shipment management table data 203 to the scheduled date of shipment in the shipment forecast data 1 (208) to compute a scheduled delivery date. The program 305 compares the computed scheduled delivery date with the requested delivery date in the shipment management table data 203 to determine whether delivery will be delayed or not (S153).

If the program 305 determines at Step 153 that delivery will be delayed, it sets “1” (error) on the counter (S154).

Then, the program 305 compares the scheduled quantity shipped in the shipment forecast data 1 (208) with the quantity ordered in the shipment management table data 203 to determine whether or not they agree with each other (S155).

If the program 305 determines at Step 155 that the scheduled quantity shipped and the quantity ordered disagree with each other, it sets “1” (error) on the counter (S156).

Then, the program 305 checks the setting of the counter. If the counter setting is “0” (S157), the program 305 further checks whether the setting of the shipment forecast error flag is “0” or not (S158). If the setting of the flag is not “0,” the program 305 sets “Overdue shipment forecast data” for the item of message in the shipment forecast data 2 (209) and “0” for the shipment forecast error flag in the shipment management table data 203 (S159).

If when the program 305 checks the setting of the counter, the counter setting is “0” (S157) and at the same time, the setting of the checked shipment forecast error flag is “0” (S158), the following takes place: in this case, the contents of the shipment forecast data 1 (208) are normal; therefore, the program 305 sets nothing for the item of message in the shipment forecast data 2 (209). If when the program 305 checks the setting of the counter, the counter setting is not “0” (S157), it performs the following operation: the program 305 sets “The delivery date or quantity delivered in the shipment forecast data disagrees with the contents of the order.” for the item of message in the shipment forecast data 2 (209). Further, the program 305 sets “1” for the shipment forecast error flag in the shipment management table data 203 (S160).

Then, the program 305 stores in the magnetic recorder 220 the shipment management table data 203 with the scheduled quantity shipped, scheduled date of shipment, and shipment forecast error flag updated (S161).

Then, based on the shipment forecast data 1 (208) read at Step 150, the program 305 sets the following items: dealer name, product name, quantity ordered, ordering unit, requested delivery date, scheduled date of shipment, scheduled quantity shipped, point of purchase, and the like. Based on the shipment management table data 203 updated at Step 160, the program 305 sets purchaser name, purchaser purchase order number, purchaser order item number, shipment forecast error flag, and the like to create shipment forecast data 2 (209). The program 305 transmits the created shipment forecast data 2 (209) to the purchaser server 100 (S162). Then, it determines whether processing of the shipment forecast data 1 (208) has been completed (S163). The program 305 repeats the processing of Steps 150 to S162 until it determines at Step 163 that the processing has been completed. If the program 305 determines at 163 that the processing has been completed, it terminates the processing.

The shipment result confirmation processing program 306 reads shipment result data 1 (210) (S170). Subsequently, using dealer name, dealer purchase order number, dealer order item number, and the like as keys, it reads shipment management table data 203 (S171).

The program 306 adds the actual quantity shipped in the shipment result data 1 (210) to the scheduled quantity shipped in the shipment management table data 203, and sets “0” on the counter (counter clear processing) (S172). Then, the program 306 adds the shipment and delivery lead time (estimated shipment and delivery time for the given product) in the shipment management table data 203 to the actual date of shipment in the shipment result data 1 (210) to compute a scheduled delivery date. The program 306 compares the computed scheduled delivery date with the requested delivery date in the transaction management table data 203 to determine whether delivery will be delayed or not (S173).

If the program 306 determines at Step 173 that delivery will be delayed, it sets “1” (error) on the counter (S174).

Then, the program 306 compares the actual quantity shipped in the shipment result data 1 (210) with the quantity ordered in the shipment management table data 203 to determine whether they agree with each other or not (S175).

If the program 306 determines at Step 175 that the actual quantity shipped and the quantity ordered disagree with each other, it sets “1” (error) on the counter (S176).

Then, the program 306 checks the setting of the counter. If the counter setting is “0” (S177), the program 306 further checks the setting of the shipment result error flag is “0” or not (S178). If the setting of the flag is not “0”, the program 306 sets “Overdue shipment result data” for the item of message in the shipment result data 2 (211) and “0” for the shipment result error flag in the shipment management table data 203 (S179).

If when the program 306 checks the setting of the counter, the counter setting is “0” (S177) and at the same time, the setting of the checked shipment result error flag is “0” (S178), the following takes place: in this case, the contents of the shipment result data 1 (210) are normal; therefore, the program 306 sets nothing for the item of message in the shipment result data 2 (211).

If when the program 306 checks the setting of the counter, the counter setting is not “0” (S177), it performs the following operation: the program 306 sets “The delivery date or quantity delivered in the shipment result data disagrees with the contents of the order.” as the message in the shipment result data 2 (211). Further, the program 306 sets “1” for the shipment result error flag in the shipment management table data 203 (S180).

Then, the program 306 stores in the magnetic recorder 220 the shipment management table data 203 with the actual quantity shipped, actual date of shipment, and shipment result error flag updated (S181).

Then, based on the shipment result data 1 (210) read at Step 170, the program 306 sets the following items: dealer name, product name, quantity ordered, ordering unit, requested delivery date, actual date of shipment, actual quantity shipped, point of purchase, supplier name, supplier invoice number, supplier invoice item number, and the like. Based on the shipment management table data 203 updated at Step 181, the program 306 sets purchaser name, purchaser purchase order number, purchaser order item number, shipment result error flag, and the like to create shipment result data 2 (211). The program 306 transmits the created shipment result data 2 (211) to the purchaser server 100 (S182).

Then, the program 306 determines whether processing of the shipment result data 1 (210) has been completed (S183). The program 306 repeats the processing of Steps 170 to 182 until it determines at Step 183 that the processing has been completed. If the program 306 determines at Step 183 that the processing has been completed, it terminates the processing.

The delivery result confirmation processing program 307 reads delivery result data 1 (212) (S190). Subsequently, using purchaser name, purchaser purchase order number, purchaser order item number, and the like as keys, it reads shipment management table data 203 (S191). Then, the program 307 adds the actual quantity delivered in the delivery result data 1 (212) to the actual quantity delivered in the shipment management table data 203, and sets “0” for the delivery result error flag in the shipment management table data 203 (S1192).

Then, the program 307 compares the actual delivery date in the delivery result data 1 (212) with the requested delivery date in the shipment management table data 203 to determines whether delivery will be delayed or not (S193).

If the program 307 determines at Step 193 that delivery will be delayed, it sets “1” (error) for the delivery result error flag in the shipment management table data 203 (S194).

Then, the program 307 compares the actual quantity delivered in the delivery result data 1 (212) with the quantity ordered in the shipment management table data 203 to determine whether they agree with each other or not (S195). If the program 307 determines at Step 195 that the actual quantity delivered and the quantity ordered disagree with each other, it sets “1” (error) for the delivery result error flag in the shipment management table data 203 (S196).

If the setting of the delivery result error flag is “1” (S198), the program 307 sets “The delivery date or quantity delivered in the delivery result data disagrees with the contents of the order.” as the message in the delivery result data 2 (213) (S199). If the setting of the delivery result error flag is “0” (S198), that is normal; therefore, the program 307 sets nothing for the item of message in the delivery result data 2 (213).

Then, the program 307 stores in the magnetic recorder 220 the shipment management table data 203 with the actual quantity delivered, actual delivery date, and delivery result error flag updated (S200).

Then, based on the delivery result data 1(212) read at Step 190, the program 307 sets the following items: dealer name, purchaser name, product name, quantity ordered, ordering unit, requested delivery date, actual delivery date, actual quantity delivered, point of purchase, and the like. Based on the shipment management table data 203 updated at Step 200, the program 307 sets supplier name, dealer purchase order number, dealer order item number, delivery result error flag, and the like to create delivery result data 2 (213). The program 307 transmits the created delivery result data 2 (213) to the supplier server 400 (S201).

Then, the program 307 determines whether processing of the delivery result data 1 (212) has been completed (S202). The program 307 repeats the processing of Steps 190 to 201 until it determines at Step 202 that the processing has been completed. If the program 307 determines at Step 202 that the processing has been completed, it terminates the processing.

The shipment and delivery situation confirmation processing program 308 reads reference keys inputted at terminal devices for referencing, such as the purchaser terminal 105, dealer terminal 201, and supplier terminal 405 (S210). The program 308 refers to the shipment management table data 203 based on the reference keys. Then, the program 308 displays the following on the terminal devices: selected quantity ordered, requested delivery date, scheduled date of shipment, scheduled quantity shipped, actual date of shipment, actual quantity shipped, actual delivery date, actual quantity delivered, and the like (S211).

Then, the program 308 determines whether referencing input from the terminal device has been all completed or not (S212). The program 308 repeats the processing of Steps 210 and 211 until it determines at Step 212 that the referencing input has been completed. If the program 308 determines at Step 212 that the referencing input has been completed, it terminates the processing. The shipment and delivery situation confirmation processing program 308 refers to the shipment management table data 203 using as keys the following items inputted at the dealer terminal device 201: a purchaser name, purchaser purchase order number, and purchaser order item number; or a dealer name, dealer received order number, and dealer received order item number; or a dealer name, dealer purchase order number, and dealer order item number; or a supplier name, supplier invoice number, and supplier invoice item number; or the like. Then, the program 308 displays the following on the dealer terminal 201: quantity ordered, requested delivery date, scheduled date of shipment, scheduled quantity shipped, actual date of shipment, actual quantity shipped, actual delivery date, actual quantity delivered, and the like.

Further, the program 308 refers to the shipment management table data 203 using as keys the following items inputted at the purchaser terminal device 105: a purchaser name, purchaser purchase order number, and purchaser order item number; or a supplier name, supplier invoice number, and supplier invoice item number; or the like. Then, the program 308 displays the following on the purchaser terminal device 105: quantity ordered, requested delivery date, scheduled date of shipment, scheduled quantity shipped, actual date of shipment, actual quantity shipped, actual delivery date, actual quantity delivered, and the like.

Further, the program 308 refers to the shipment management table data 203 using as keys the following items inputted at the supplier terminal device 405: a purchaser name, purchaser purchase order number, and purchaser order item number; or a supplier name, supplier invoice number, and supplier invoice item number; or the like. Then, the program 308 displays the following on the supplier terminal 405: quantity ordered, requested delivery date, scheduled date of shipment, scheduled quantity shipped, actual date of shipment, actual quantity shipped, actual delivery date, actual quantity delivered, and the like.

The above embodiment has been described with the terms purchaser server 100 and the supplier server 400 used interchangeably with purchaser system 106 and supplier system 406, respectively. However, this is merely for illustrative convenience. For example, each system may have multiple servers.

Referring to FIG. 18, the shipment forecast delay notification processing program 309 reads shipment management table data 203 (S220), and sets “0” on the counter (counter clear processing) (S221).

Then, the program 309 subtracts the shipment and delivery lead time and the shipment forecast lead time from the requested delivery date in the shipment management table data 203 to compute date-time information. The program 309 compares the computed date-time information with the system date-time information in the dealer server to determine whether there is a delay or not (S222). If there is a delay, the program 309 sets “1” on the counter (S223). Next, the program 309 subtracts the shipment and delivery lead time from the requested delivery date in the shipment management table data 203 to compute date-time information. Then, the program 309 determines whether the computed date-time information is delayed from the system date-time information in the dealer server. At the same time, the program 309 determines whether the scheduled date of shipment is undetermined (scheduled date of shipment not=space) (S224). If the results of these determinations are affirmative, the program 309 sets “1” on the counter (S225).

Subsequently, the program 309 determines whether the setting of the counter is “0” or not (S226). If the counter setting is “0,” the program 309 further determines whether the setting of the shipment forecast error flag in the shipment management table data 203 is “0” or not (S227). If the setting of the flag is “0,” the program 309 sets the following items based on the shipment management table data 203 read at Step 220: dealer name, supplier name, dealer purchase order number, dealer order item number, product name, quantity ordered, ordering unit, requested delivery date, purchaser name, point of delivery, shipment forecast error flag, creation date, and the like. The program 309 sets “The transmission of shipment forecast data is delayed. Immediately transmit.” as the item of message, and creates shipment forecast delay notification data 1 (215) (S228). The program 309 transmits the created shipment forecast delay notification data 1 (215) to the supplier server 400 (S229). Then, the program 309 sets the following items based on the shipment management table data 203 read at Step 220: purchaser name, dealer name, purchaser purchase order number, purchaser order item number, product name, quantity ordered, ordering unit, requested delivery date, point of delivery, shipment forecast error flag, creation date, and the like. The program 309 sets “The transmission of shipment forecast data is delayed. Countermeasures are underway.” for the item of message to create shipment forecast delay notification data 2 (216) (S230). The program 309 transmits the created shipment forecast delay notification data 2 (216) to the purchaser server 100 (S231), and sets “1” for the shipment forecast error flag in the shipment management table data 203 (S232). Then, the program 309 stores the updated shipment management table data 203 in the magnetic recorder 220 (S233).

The program 309 determines whether processing of the shipment management table data 203 has been all completed (S234). The program 309 repeats the processing of Steps 220 to 233 until it determines at Step 234 that the processing has been completed. If the program 309 determines at Step 234 that the processing has been completed, it terminates the processing. The shipment result delay notification processing program 310 reads shipment management table data 203 (S240), and sets “0” on the counter (counter clear processing) (S241).

The program 310 subtracts the shipment and delivery lead time from the requested delivery date in the shipment management table data 203 to compute date-time information. The program 310 compares the computed date-time information with the system date-time information in the dealer server to determine whether there is a delay (S242). If there is a delay, the program 310 sets “1” on the counter (S243).

Next, the program 310 determines whether the scheduled date of shipment in the shipment management table data 203 is delayed from the system date-time information in the dealer server. At the same time, the program 310 determines whether the scheduled date of shipment has been determined (scheduled date of shipment not=space). At the same time, the program 310 determines whether the actual date of shipment has not been determined (actual date of shipment=space) (S244). If the results of these judgments are affirmative, the program 310 sets “1” on the counter (S245).

Subsequently, the program 310 determines whether the setting of the counter is “0” or not (S246). If the counter setting is “0,” the program 310 further determines whether the setting of the shipment result error flag in the shipment management table data 203 is “0” or not (S247). If the setting of the flag is “0,” the program 310 sets the following items based on the shipment management table data 203 read at Step 240: dealer name, supplier name, dealer purchase order number, dealer order item number, product name, quantity ordered, ordering unit, requested delivery date, purchaser name, point of delivery, shipment result error flag, creation date, and the like. The program 310 sets “The transmission of shipment result data is delayed. Immediately transmit.” for the item of message to create shipment result delay notification data 1 (217) (S248). The program 310 transmits the created shipment result delay notification data 1 (217) to the supplier server 400 (S249). Then, the program 310 sets the following items based on the shipment management table data 203 read at Step 240: purchaser name, dealer name, purchaser purchase order number, purchaser order item number, product name, quantity ordered, ordering unit, requested delivery date, point of delivery, shipment result error flag, creation date, and the like. The program 310 sets “The transmission of shipment result data is delayed. Countermeasures are underway.” as the item of message to create shipment result delay notification data 2 (218) (S250). The program 310 transmits the created shipment result delay notification data 2 (218) to the purchaser server 100 (S251), and sets “1” for the shipment result error flag in the shipment management table data 203 (S252). Then, the program 310 stores the updated shipment management table data 203 in the magnetic recorder 220 (S253).

Then, the program 310 determines whether processing of the shipment management table data 203 has been all completed (S254). The program 310 repeats the processing of Steps 240 to 253 until it determines at Step 254 that the processing has been completed. If the program 310 determines at Step 254 that the processing has been completed, it terminates the processing.

With the shipment and delivery management system in this embodiment, the following effects are obtained:

(1) With respect to the management of shipment and delivery of articles of trade in the distributive trade, the following effect is obtained: based on shipment forecast notification information from the supplier and taking the purchaser's requested delivery date into account, the dealer can notify the purchaser of any delay and request the supplier to take appropriate measures against the delay in a timely manner. Thus, the dealer can take proactive measures to avoid any delivery delay problem from occurring.

(2) With respect to the management of shipment and delivery of articles of trade in the distributive trade, the following effect is obtained: if the receipt of a shipment forecast notification from the supplier is delayed, the dealer can take the purchaser's requested delivery date into account and can notify the purchaser of the possible delay and request the supplier to take appropriate measures against the delay in a timely manner. Thus, the dealer can take measures proactively before any delivery problem arises.

(3) With respect to the management of shipment and delivery of articles of trade in the distributive trade, the following effect is obtained: based on shipment result notification information from the supplier and taking the purchaser's requested delivery date into account, the dealer can notify the purchaser of any delay and request the supplier to take appropriate measures against the delay in a timely manner. Thus, the dealer can promptly take measures against any shipment problem that has occurred.

(4) With respect to the management of shipment and delivery of articles of trade in the distributive trade, the following effect is obtained: if the receipt of a shipment result notification from the supplier is delayed, the dealer can take the purchaser's requested delivery date into account and can notify the purchaser of the delay and request the supplier take measures against the delay in a timely manner. Thus, the dealer can take measures against any problem that has occurred.

(5) With respect to (1) to (4) above, another effect is obtained if a shipment forecast notification from the supplier is delayed but a problem related to the delivery date is solved by requesting the supplier to take measures: based on shipment forecast information received from the supplier, the shipment and delivery management system in this embodiment can cancel the notification of possible delay to the purchaser.

Similarly, another effect is obtained if a shipment result notification from the supplier is delayed but a problem related to the delivery date is solved by requesting the supplier to take measures: based on the received shipment result information, the shipment and delivery management system in this embodiment can notify the purchaser of the avoidance of delay.

(6) With use of the management system for shipment and delivery of articles of trade which is an embodiment of the present invention, the following effect is obtained: the dealer can carry out the management of shipment and delivery of articles of trade between the dealer, and the purchaser and the supplier without carrying an inventory in a timely manner. Thus, the dealer can reduce the quantity of trade inventory which the dealer secures for the enhancement of accuracy of shipment and delivery management.

1. A method for managing product transaction information of a purchaser, dealer, and supplier, the method comprising:
providing a shipment management table on a on storage device of a dealer server, the shipment management table including purchaser transaction reference information, dealer transaction reference information, supplier transaction reference information, product delivery date requested by the purchaser, the scheduled shipping date of the product by the supplier, the requested product delivery date being generated by purchase order information received from the purchaser and the anticipated shipping date being generated by information provided by the supplier;
comparing the requested product delivery date and the anticipated shipping by accessing the shipment management table stored in the storage device;
determining whether or not the anticipated shipping date satisfies the requested delivery date requested by the purchaser; and
transmitting a message notifying at least to one of the purchaser and supplier of a delivery problem if the anticipated shipping date is determined to be unsatisfactory with respect to the requested delivery date, the message being transmitted to a network coupled to the dealer server.

2. The method of claim 1, further comprising:
generating a transaction management table relating to a product purchase order involving the purchaser, dealer, and a supplier.

3. The method of claim 2, wherein the transaction management table includes purchaser information, dealer information, supplier information, shipment-related lead time information, and shipment forecast lead time

4. The method of claim 1, wherein the message is transmitted to the supplier to request the supplier to alert the supplier of the delivery problem.

5. The method of claim 4, wherein the message requests the supplier to take an appropriate action to resolve the delivery problem.

6. The method of claim 1, wherein the shipping management table includes the number of products that has been ordered by the purchaser, wherein the shipping management table is used to determine whether or not the supplier is intending to deliver the same number of products to the purchaser.

7. The method of claim 1, further comprising:
determining whether or not the supplier has provided the anticipated shipping date.

8. The method of claim 7, further comprising:
transmitting a request to the supplier to provide the anticipated shipping date if it is determined that the anticipated shipping date has not received the anticipated shipping information.

9. The method of claim 1, further comprising:
receiving a request to access the shipment management table stored in the storage device of the dealer server from a purchaser system; and
granting the access request received from the purchaser system, so that a user at the purchaser can check the anticipated delivery date.

10. A dealer server system for managing product transaction information involving a purchaser, dealer, and supplier, the dealer server system comprising:
means for providing a shipment management table on a on storage device of a dealer server, the shipment management table including purchaser transaction reference information, dealer transaction reference information, supplier transaction reference information, product delivery date requested by the purchaser, the scheduled shipping date of the product by the supplier, the requested product delivery date being generated by purchase order information received from the purchaser and the anticipated shipping date being generated by information provided by the supplier;
means for comparing the requested product delivery date and the anticipated shipping by accessing the shipment management table stored in the storage device;
means for determining whether or not the anticipated shipping date satisfies the requested delivery date requested by the purchaser; and
means for transmitting a message notifying at least to one of the purchaser and supplier of a delivery problem if the anticipated shipping date is determined to be unsatisfactory with respect to the requested delivery date, the message being transmitted to a network coupled to the dealer server.

11. The dealer server system of claim 10, further comprising:
means for generating a transaction management table relating to a product purchase order involving the purchaser, dealer, and a supplier.

12. The dealer server system of claim 11, wherein the transaction management table includes purchaser information, dealer information, supplier information, shipment-related lead time information, and shipment forecast lead time

13. The dealer server system of claim 1, further comprising:
means for determining whether or not the supplier has provided the anticipated shipping date.

14. The dealer server system of claim 13, further comprising:
means for transmitting a request to the supplier to provide the anticipated shipping date if it is determined that the anticipated shipping date has not received the anticipated shipping information.

15. A computer readable medium including a computer program for managing product transaction information of a purchaser, dealer, and supplier, the computer program comprising:
code for providing a shipment management table on a on storage device of a dealer server, the shipment management table including purchaser transaction reference information, dealer transaction reference information, supplier transaction reference information, product delivery date requested by the purchaser, the scheduled shipping date of the product by the supplier, the requested product delivery date being generated by purchase order information received from the purchaser and the anticipated shipping date being generated by information provided by the supplier;
code for comparing the requested product delivery date and the anticipated shipping by accessing the shipment management table stored in the storage device;
code for determining whether or not the anticipated shipping date satisfies the requested delivery date requested by the purchaser; and
code for transmitting a message notifying at least to one of the purchaser and supplier of a delivery problem if the anticipated shipping date is determined to be unsatisfactory with respect to the requested delivery date, the message being transmitted to a network coupled to the dealer server.

16. The computer program of claim 15, further comprising:
code for generating a transaction management table relating to a product purchase order involving the purchaser, dealer, and a supplier.

17. The computer program of claim 16, wherein the transaction management table includes purchaser information, dealer information, supplier information, shipment-related lead time information, and shipment forecast lead time

18. The computer program of claim 15, further comprising:
code for receiving a request to access the shipment management table stored in the storage device of the dealer server from a purchaser system; and
code for granting the access request received from the purchaser system, so that a user at the purchaser can check the anticipated delivery date.

19. A dealer server for managing product transaction information involving a purchaser, dealer, and supplier, the server system comprising:
a communication interface to couple the dealer server to a purchaser computer and a supplier computer;
a processor to process information; and
a storage device to store the product transaction information involving the purchaser, dealer, and supplier;
wherein the dealer sever is configured to store a shipment management table on a on storage device of a dealer server, the shipment management table including purchaser transaction reference information, dealer transaction reference information, supplier transaction reference information, product delivery date requested by the purchaser, the scheduled shipping date of the product by the supplier, the requested product delivery date being generated by purchase order information received from the purchaser and the anticipated shipping date being generated by information provided by the supplier;
compare the requested product delivery date and the anticipated shipping by accessing the shipment management table stored in the storage device;
determine whether or not the anticipated shipping date satisfies the requested delivery date requested by the purchaser; and
transmit a message notifying at least to one of the purchaser and supplier of a delivery problem if the anticipated shipping date is determined to be unsatisfactory with respect to the requested delivery date, the message being transmitted to a network coupled to the dealer server.
